(19) United States
(12) Patent Application Publication
(10) Pub. No.: US 2017/0256011 A1
(43) Pub. Date: Sep. 7, 2017

(54) AFTER DEATH VIDEOS

(71) Applicant: Jason N. Statom, Oklahoma City, OK (US)

(72) Inventor: Jason N. Statom, Oklahoma City, OK (US)

(21) Appl. No.: 15/371,105

(22) Filed: Dec. 6, 2016

Related U.S. Application Data
(60) Provisional application No. 62/302,466, filed on Mar. 2, 2016.

(51) Int. Cl. G06Q 50/18; H04L 29/08; G06Q 30/06

(52) U.S. Cl. CPC G06Q 50/186; G06Q 30/0635; H04L 67/306; H04L 67/10; H04L 67/02

(57) ABSTRACT

A method for memorializing a person after death, includes the steps of: a) signing up, by the customer prior to death, and creating an asccount on a website; b) making, by the customer prior to death, the chosen videos from the final farewell video, and/or the funeral video, and/or the timeline video; c) uploading, by the customer prior to death, the chosen videos; d) creating recipients aka lights of whom will receive the videos after death; e) assigning the final farewell videos to the recipients; f) advising by the customer, friends, or family members that the customer has created a final farewell video; g) verifying death of the customer; h) authorizing release of the final farewell videos to the recipients; and i) viewing the video.

### CROSS REFERENCE TO RELATED APPLICATIONS

The instant non-provisional patent application claims priority from provisional patent application number 62/302,466, filed on Mar. 2, 2016, for AFTER DEATH VIDEOS OR ADV FOR SHORT, and which is incorporated herein in its entirety by reference thereto.

### BACKGROUND OF THE INVENTION

Field of the Invention

The embodiments of the present invention relate to a method for memorializing, and more particularly, the embodiments of the present invention relate to a method for memorializing a person after death.

Description of the Prior Art

Have you ever been “visited” in your dreams by that special friend or loved one that has passed away, and you woke up the next day feeling rejuvenated and all around better due to the deceased advising you to “hang in there” and that things will get better?

Numerous innovations for video creations have been provided in the prior art. Even though these innovations may be suitable for the specific individual purposes to which they address, nevertheless, they differ from the embodiments of the present invention.

### SUMMARY OF THE INVENTION

Thus, an object of the embodiments of the present invention is to provide a method for memorializing a person after death, which avoids the disadvantages of the prior art.

The embodiments of the present invention eliminate a need to wait until a deceased's love ones and friends appear in a user's dreams to provide the user with a message that the user will be able to keep forever and watch whenever the user wishes. The deceased can leave an inspirational video message, namely, a final farewell video to those special people or recipients in the deceased's life to be played after the deceased's passing to help alleviate the pain of those that are left behind.

While the majority of people plan on living well into their golden years, the reality is many people may not make it. Wouldn't it be nice to have that comfort of knowing in the event of one's possibly untimely death one would be able to leave a lasting message for one's friends or family that they will be able to keep forever and view at anytime.

The purpose of the embodiments of the present invention is to allow customers to privately and securely hold personal videos, only to be released upon verification of their death, to specified cellular numerals or email addresses.

Briefly stated, another object of the embodiments of the present invention is to provide a method for memorializing a person after death, including the steps of: a) signing up, by the customer prior to death and creating an account on a website; b) making, by the customer prior to death, the chosen videos from the final farewell video, and/or the funeral video, and/or the timeline video; c) uploading, by the customer prior to death, the chosen videos; d) creating recipients of whom will receive the videos after the customer's death; e) assigning the final farewell videos to the recipients; f) advising by the customer, friends, or family members that the customer has created a final farewell video; g) verifying death of the customer; h) authorizing release of the final farewell videos to the recipients; and i) viewing/saving the video.

The novel features considered characteristic of the embodiments of the present invention are set forth in the appended claims. The embodiments of the present invention themselves, however, both as to their construction and to their method of operation together with additional objects and advantages thereof will be best understood from the following description of the embodiments of the present invention when read and understood in connection with the accompanying figures of the drawing.

### BRIEF DESCRIPTION OF THE FIGURES OF THE DRAWING

The figures of the drawing are briefly described as follows:

FIGS. 1A-1E are a flowchart of the mandatory steps of the method of the embodiments of the present invention for memorializing a person after death; and

FIGS. 2A-2G are a flowchart of the optional steps of the method of the embodiments of the present invention for memorializing a person after death.

### DETAILED DESCRIPTION OF THE PREFERRED EMBODIMENTS

### Introductory

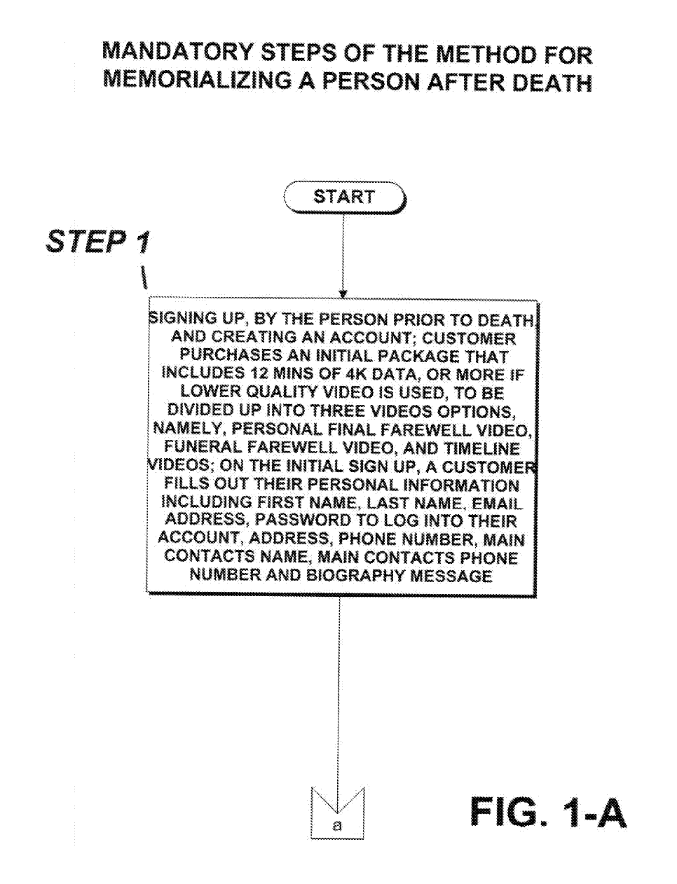

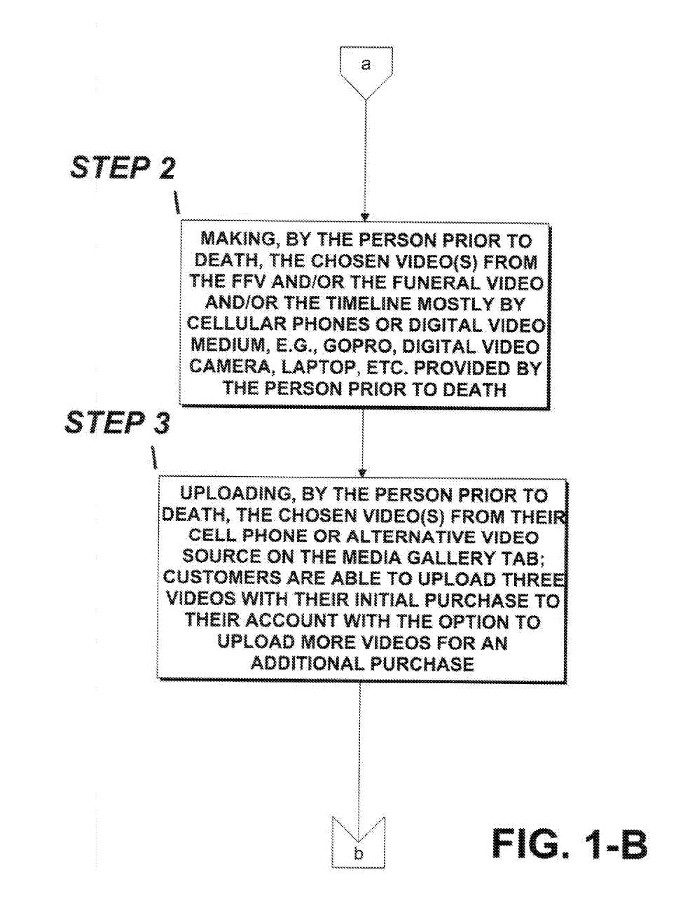

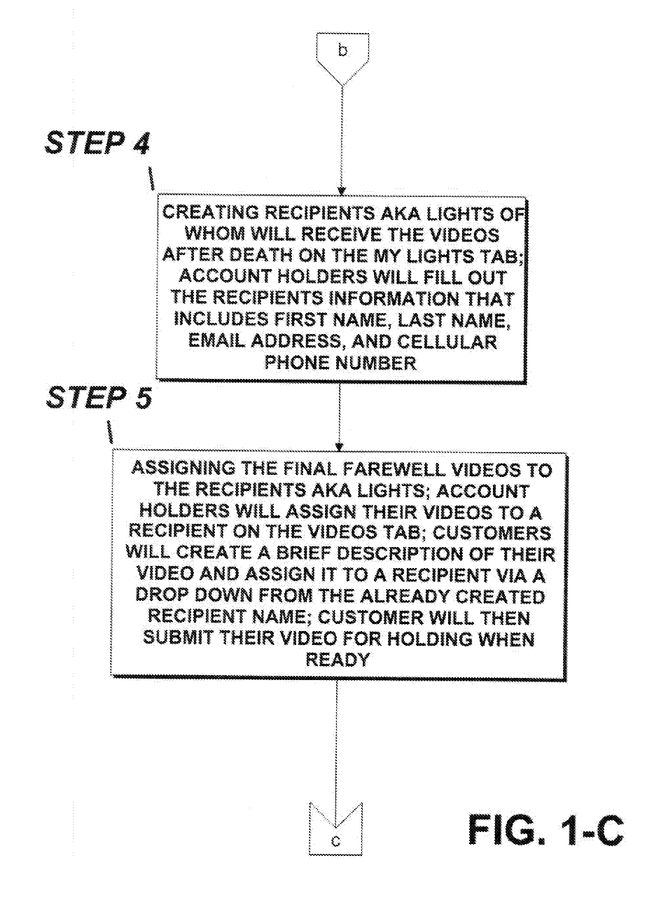

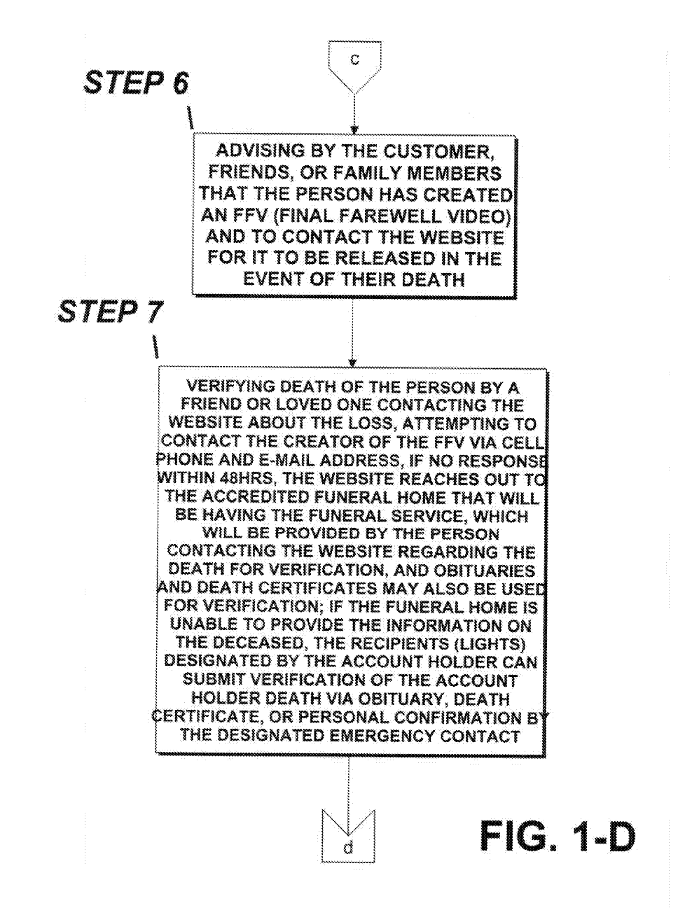

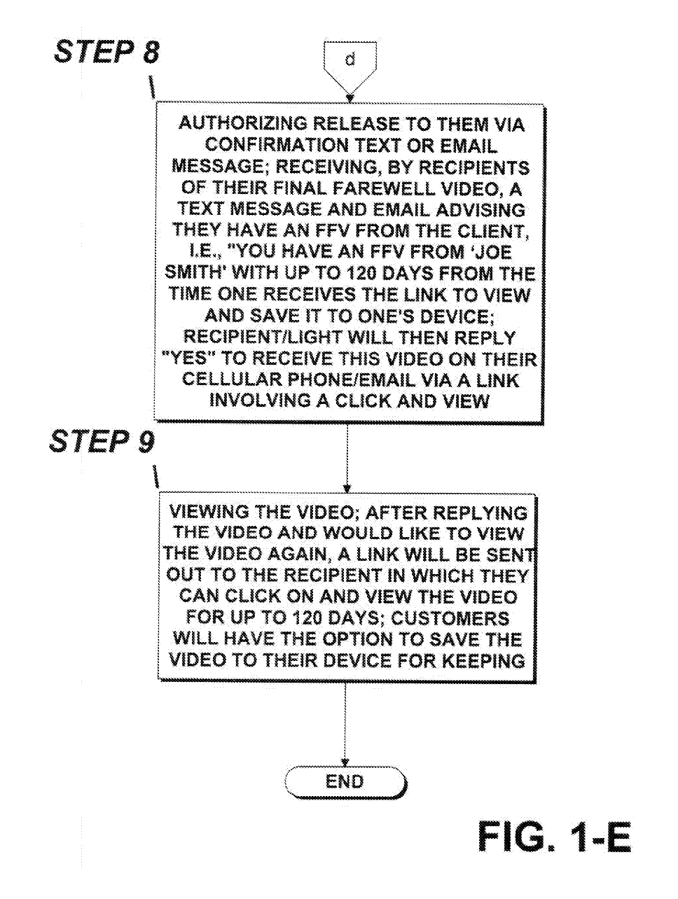

Referring now to FIGS. 1A-1E, the mandatory steps of the method of the embodiments of the present invention for memorializing a person after death is shown.

### Mandatory Steps of the Method for Memorializing a Person after Death

The method for memorializing a person after death, comprises the mandatory steps of:

STEP 1: Signing up, by the customer prior to death, and creating an account on a website. The customer purchases an initial package that includes 12 mins of 4k data, or more if a lower quality video is used, and is to be divided up into three videos options, namely, a final farewell video, a funeral video, and a timeline video. On the initial sign up, the customer fills out their personal information including a first name, a last name, an email address, a password to log into their account, an address, a phone number, a main contact's name, a main contact's phone number, and a biography message.

STEP 2: Making, by the customer prior to death, the chosen video(s) from the final farewell video and/or the funeral video and/or the timeline video mostly by cellular phones or digital video medium, e.g., GoPro, digital video camera, laptop, etc. provided by the customer prior to death.

STEP 3: Uploading, by the customer prior to death, the chosen video(s) from their cell phone or alternative video source on a media gallery tab on the website. The customers are able to upload three videos with their initial purchase to their account, with the option to upload more videos for an additional purchase.

STEP 4: Creating recipients aka Lights of whom will receive the videos after death on a my lights tab of the website. Customers will fill out the recipients information including a first name, a last name, an email address, and a cellular phone number.

STEP 5: Assigning the final farewell videos to the recipients. The customers will assign their videos to a recipient on a Assign FFV tab of the website. The customers will create a brief description of their video and assign it to a recipient via a drop down of the website from an already created recipient name. Customer will then submit their video for holding when ready.

STEP 6: Advising by the customer, friends, or family members that the person has created a final farewell video and to contact the website for it to be released in the event of their death.

STEP 7: Verifying death of the customer by a friend or loved one contacting the website about the loss, attempting to contact the creator of the final farewell video via cell phone and e-mail address. If no response within 48 hrs, the website reaches out to an accredited funeral home that will be having the funeral service at, which will be provided by the person contacting the website regarding the death for verification. Obituaries and death certificates may also be used for verification. If the Funeral home is unable to provide the information on the deceased, the recipients designated by the customer can submit verification of the customer's death via an obituary, a death certificate, or a personal confirmation by the designated emergency contact.

STEP 8: Authorizing release of the final farewell video to the recipients via a confirmation text or email message. Receiving, by recipients of the final farewell videos, a text message and an email advising they have a final farewell video from the customer, e.g., “You have a final farewell video from ‘Joe Smith,’ with up to 120 days from a time the recipient receives a link to view and save it to the recipient's device. The recipient will then reply “yes” to receive the final farewell video on their cellular phone/email via a link involving a click and view on the website.

STEP 9: Viewing the video. After replying and the recipient would like to view the video again, a link will be sent out to the recipient in which the recipient can click on the website and view the video for up to 120 days. The recipients will have an option to save the video to their device for keeping.

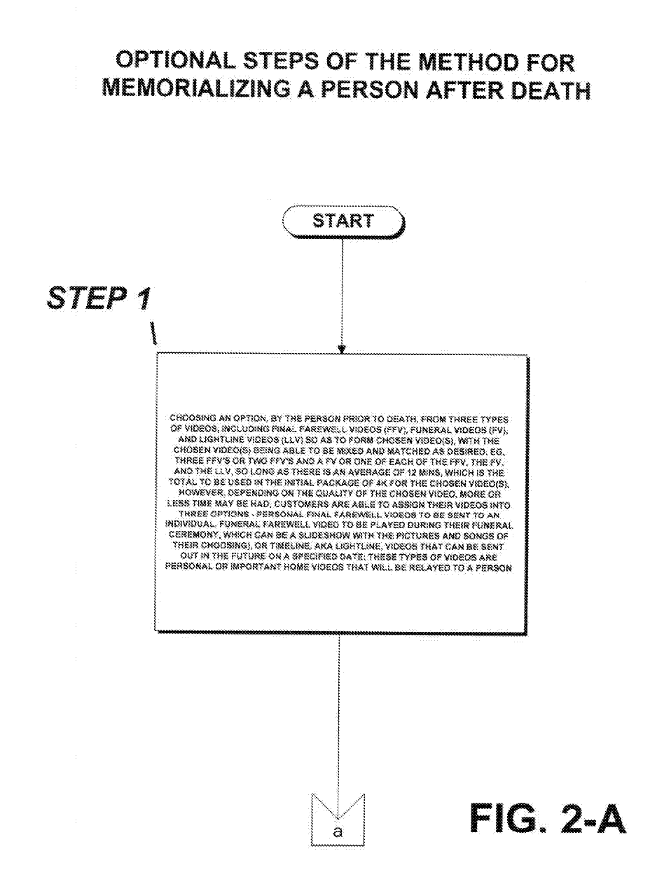

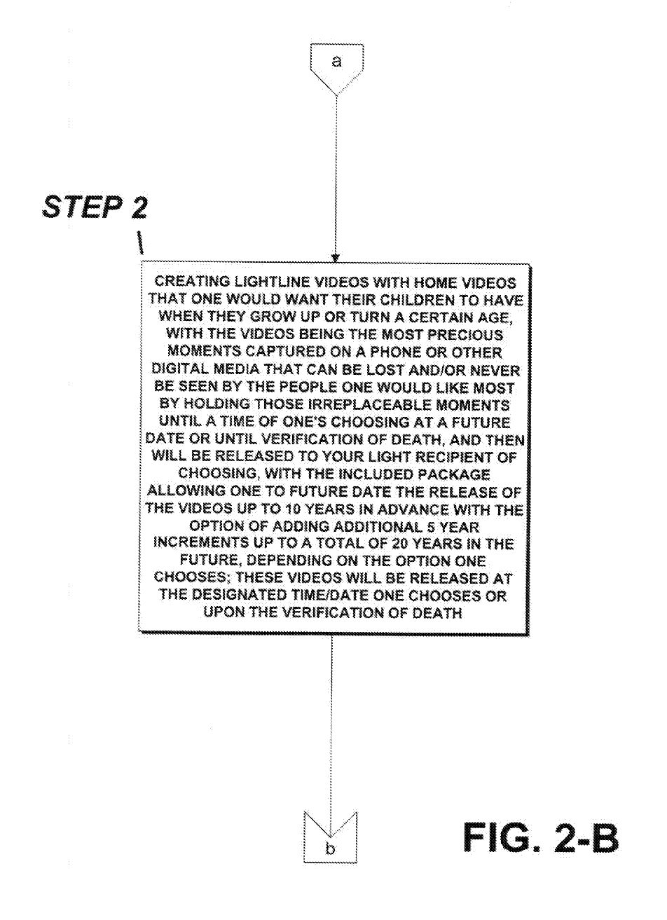

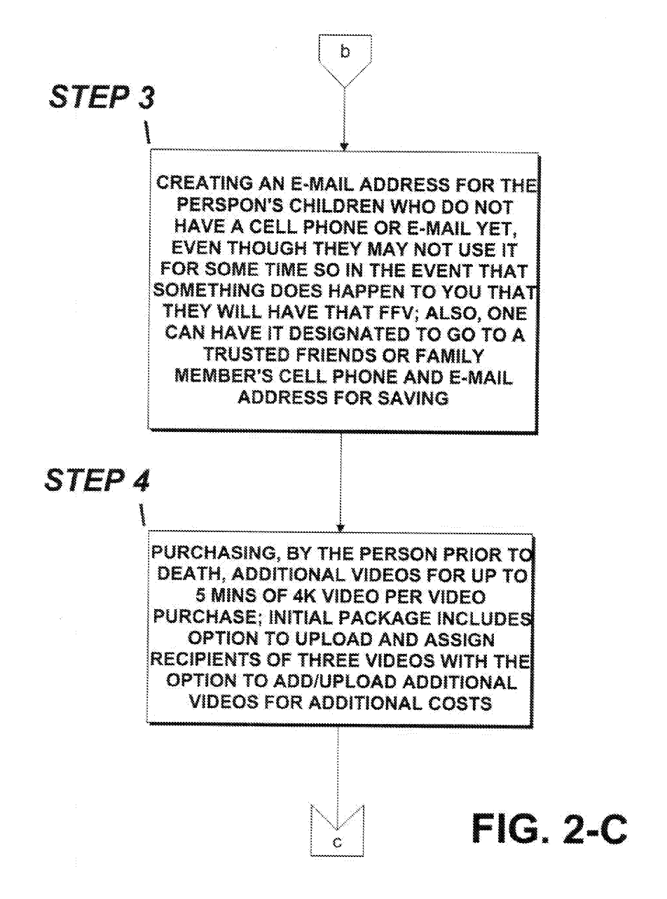

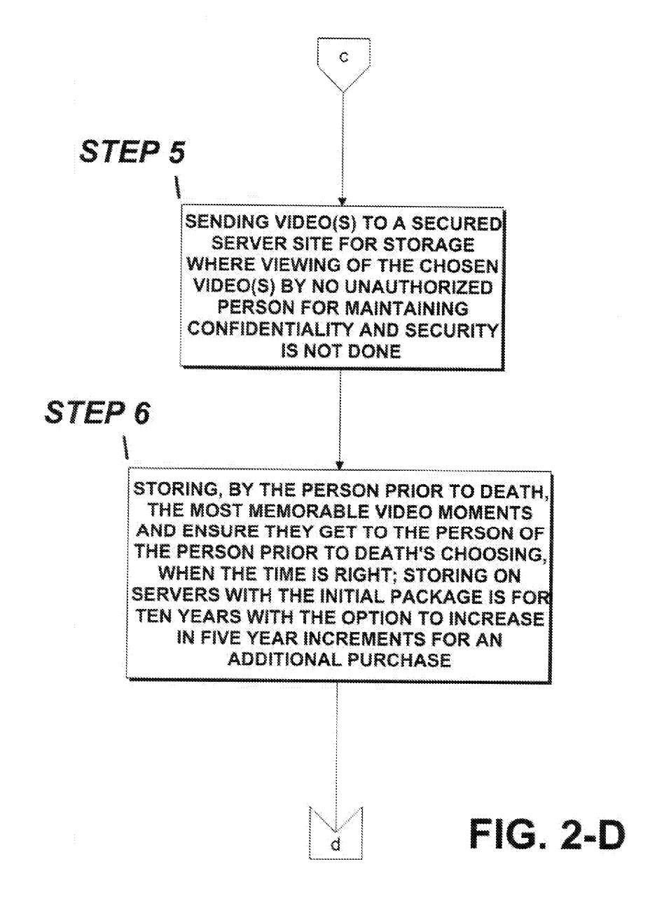

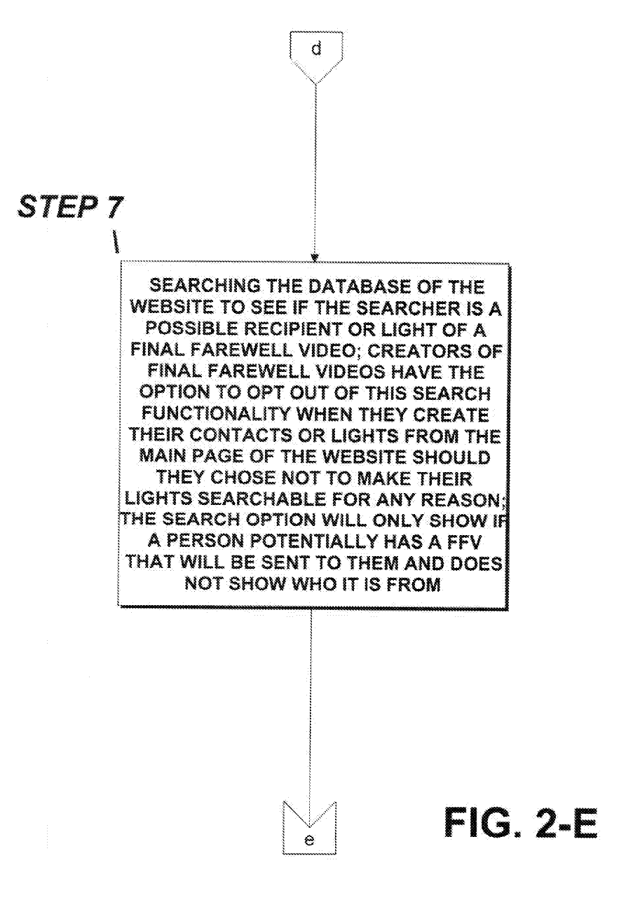

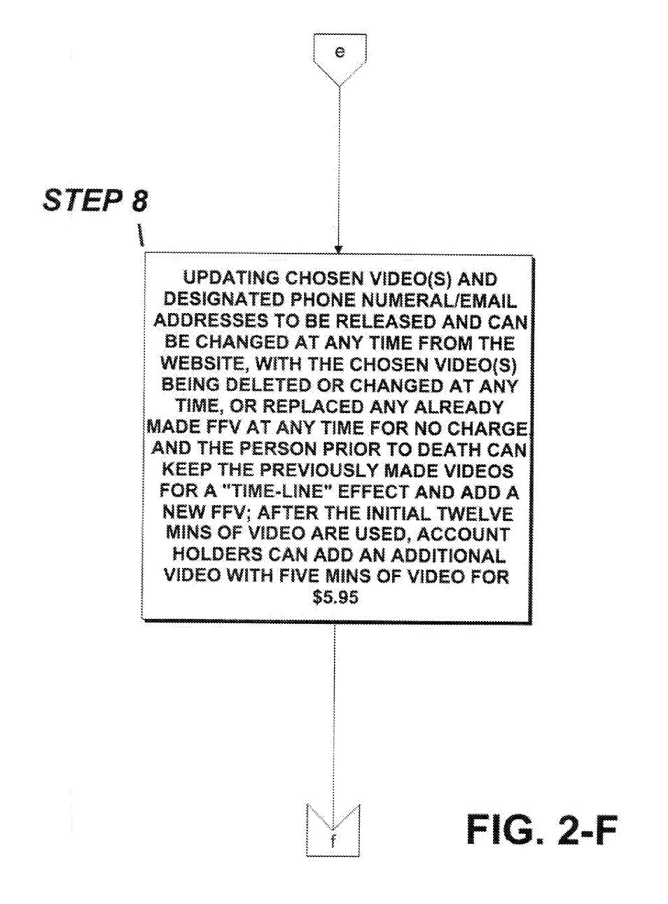

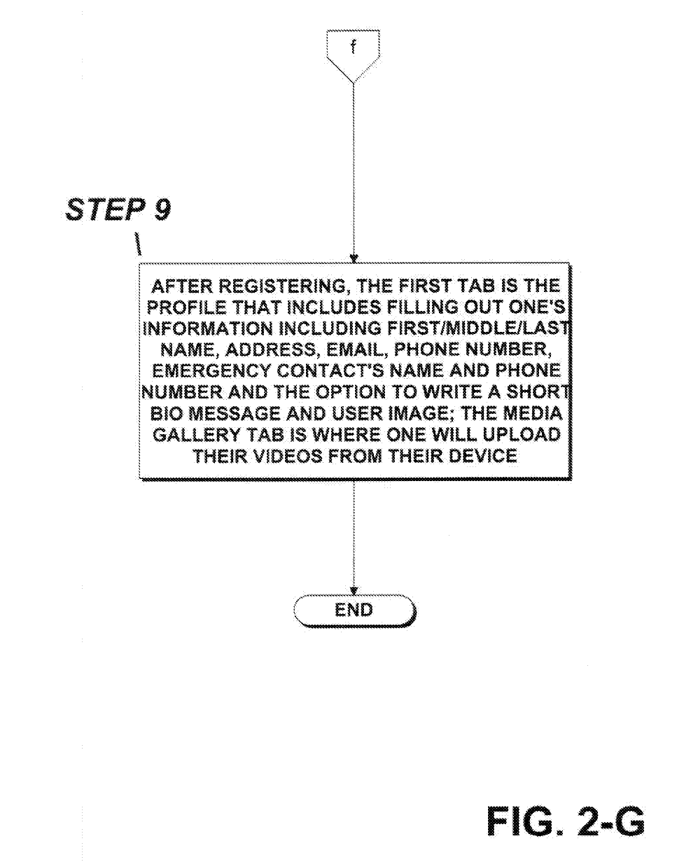

Referring now to FIGS. 2A-2G, the optional steps of the method of the embodiments of the present invention for memorializing a person after death is shown.

### Optional Steps of the Method for Memorializing a Person after Death

The method for memorializing a person after death, comprises the optional steps of:

STEP 1: Choosing an option, by the customer prior to death, from three types of videos, including final farewell videos, funeral videos, and timeline videos so as to form chosen videos. The chosen videos are able to be mixed and matched as desired, e.g., three final farewell videos or two final farewell videos and a funeral video, or one of each of the final farewell video, the funeral video, or the timeline video, so long as there is an average of 12 mins, which is the total to be used in the initial package of 4K for the chosen videos, however, depending on the quality of the chosen video, more or less time may be had. The customers are able to assign their videos into three options, namely, the final farewell videos to be sent to recipients, the funeral video to be played during their funeral ceremony, which can be a slide-show with pictures and songs of their choosing, or the timeline videos that can be sent out in the future on a specified date. These types of videos are personal or important home videos that will be relayed to a person/persons of the customer's choosing.

STEP 2: Creating Timeline videos with home videos that one would want their children to have when they grow up or turn a certain age. The videos are the most precious moments captured on a phone or other digital media that can be lost and/or never be seen by the people one would like most by holding those irreplaceable moments until a time of one's choosing at a future date or until verification of death, and then will be released to the recipient of choosing. The included package allows one to future date release of the videos up to 10 years in advance, with the option of adding additional 5 year increments up to a total of 20 years in the future, depending on the option the customer chooses. These videos will only be released at the designated time/date the customer chooses.

STEP 3: Creating an e-mail address for the customer's children who do not have a cell phone or e-mail yet, even though they may not use it for some time so in the event that something does happen to the customer that they will have that final farewell video. Also, the customer can have it designated to go to a trusted friends or family member's cell phone and e-mail address for saving.

STEP 4: Purchasing, by the customer prior to death, additional videos for up to 5 mins of 4k video per video purchase. The initial package includes options to upload and assign recipients of three videos, with the option to add/upload additional videos for additional costs.

STEP 5: Sending videos to a secured server site for storage where viewing the chosen videos by no unauthorized person for maintaining confidentiality and security is not done.

STEP 6: Storing, by the customer prior to death, the most memorable video moments and ensure they get to the recipient of the customer's prior to death choosing, when the time is right. Storing on servers with the initial package is for ten years, with the option to increase in five year increments for an additional purchase.

STEP 7: Searching a database of the website to see if a friend or loved one has created a FFV to be released after their death. Creators of the final farewell videos have an option to opt out of this search functionality when they create their account from a main page of the website should they chose not to make themselves searchable for any reason. The search option will only show if the account holder potentially has made a final farewell video or Light Line video that is set to be released upon verification of their death and does not show who it is to.
STEP 8: Updating the chosen videos and designated phone numbers/email addresses to be released at any time from the website. The chosen videos are deleted or changed at any time, or replace any already made final farewell video at any time for no charge, and the customer prior to death can keep the previously made videos for a “time-line” effect and add a new final farewell video. After the initial twelve mins of video are used, customers can add an additional video with five mins of video for $5.95.

STEP 9: After registering, the first tab of the website is the profile that includes filling out the customer's information including first/middle/last names, an address, an email, a phone number, an emergency contact's name and phone number and an option to write a short bio message and user image. The media gallery tab of the website is where the customer will upload their videos from their device.

STEP 10: The initial length of time for the included package for the videos to be stored is ten years with the option to add additional lengths of time to be kept for an additional purchase in five year increments.

### Impressions

It will be understood that each of the elements described above or two or more together may also find a useful application in other types of constructions differing from the types described above.

While the embodiments of the present invention have been illustrated and described as embodied in a method for creating a video about a person prior to death of the person and have the video played after the death of the person so as to allow the person to be remembered visually and audibly, nevertheless, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

The invention claimed is:

1. A method for memorializing a customer after death, comprises the steps of:
a) signing up, by the customer prior to death, and creating an account on a website;
b) making, by the customer prior to death, chosen videos from a final farewell video and/or a funeral video, and/or a timeline video;
c) uploading, by the customer prior to death, the chosen videos;
d) creating recipients of whom will receive the videos after death;
e) assigning the final farewell videos to the recipients;
f) advising by the customer, friends, or family members that the customer has created the final farewell video;
g) verifying death of the customer;
h) authorizing release of the final farewell videos to the recipients; and
i) viewing the video.

2. The method of claim 1, wherein said signing step includes signing up, by the customer prior to death, and creating an account.

3. The method of claim 1, wherein said signing step includes the step of purchasing, by the customer, an initial package that includes 12 mins of 4k data, or more if a lower quality video is used, which is to be divided up into three videos options, namely, final farewell video, funeral video, and timeline videos.

4. The method of claim 1, wherein said signing step includes the step of filling out, on the initial sign up by the customer, the customer's personal information including first name, last name, email address, password to log into the customer's account, address, phone number, main contacts name, main contacts phone number, and a biography message.

5. The method of claim 1, wherein said making step includes making, by the customer prior to death, the chosen videos from the final farewell video and/or the funeral video and/or the timeline video.

6. The method of claim 1, wherein said making step includes making, by the customer prior to death, the chosen videos from the final farewell video and/or the funeral video and/or the timeline video mostly by cellular phones or digital video medium, including GoPro, a digital video camera, and a laptop provided by the customer prior to death.

7. The method of claim 1, wherein said uploading step includes uploading, by the customer prior to death, the chosen videos.

8. The method of claim 1, wherein said uploading step includes uploading, by the customer prior to death, the chosen videos from a cell phone or an alternative video source on a media gallery tab on the website.

9. The method of claim 1, wherein said uploading step includes uploading, by the customer prior to death, three videos with the initial purchase to their account with the option to upload more videos for an additional purchase.

10. The method of claim 1, wherein said creating step includes creating recipients of whom will receive the videos after death.

11. The method of claim 1, wherein said creating step includes creating recipients of whom will receive the videos after death on a my lights tab of the website.

12. The method of claim 1, wherein said creating step includes the step filling out, by the customer, the recipients' information that includes first name, last name, email address, and cellular phone number.

13. The method of claim 1, wherein said assigning step includes assigning the final farewell videos to the recipients.

14. The method of claim 1, wherein said assigning step includes assigning the final farewell videos to the recipients on a videos tab of the website.

15. The method of claim 1, wherein said assigning step includes the step of creating, by the customer, a brief description of their video and assigning it to the recipients via a drop down on the website from an already created recipient name.

16. The method of claim 1, wherein said assigning step includes the step of submitting, by the customer, their video for holding when ready.

17. The method of claim 1, wherein said advising step includes advising by the customer, friends, or family members that the customer has created a final farewell video.

18. The method of claim 1, wherein said advising step includes the step of contacting the website for the video to be released in the event of their death.

19. The method of claim 1, wherein said verifying step includes verifying death of the customer.

20. The method of claim 1, wherein said verifying step includes verifying death of the customer by a friend or loved one contacting the website about the loss; attempting to contact the customer of the final farewell video via cell phone and e-mail address; if no response within 48 hrs, the website reaches out to the accredited funeral home that will be having the funeral service, which will be provided by the person contacting the website regarding the death for verification; obituaries and death certificates may also be used for verification.

21. The method of claim 1, wherein said verifying step includes the step of submitting, by the recipients, verification of the account holder death via obituary, death certificate, or personal confirmation, if the Funeral home is unable to provide the information on the deceased.

22. The method of claim 1, wherein said authorizing step includes authorizing release of the videos to the recipients.

23. The method of claim 1, wherein said authorizing step includes authorizing release of the videos to the recipients via confirmation text or email message.

24. The method of claim 1, wherein said authorizing step includes the step of receiving, by the recipients of their final farewell video, a text message and email advising they have a final farewell video from the customer, with up to 120 days from the time the recipients receive the link to view and save it to the recipients' devices.

25. The method of claim 1, wherein said authorizing step includes the step of replying, by the recipients, “yes” to receive the videos on the recipients' cellular phone/email via a link involving a click and view.

26. The method of claim 1, wherein said viewing step includes viewing the video.

27. The method of claim 1, wherein said viewing step includes the step of replaying, the video via a link sent out to the recipients in which the recipients can click on and view the videos for up to 120 days.

28. The method of claim 1, wherein said viewing step includes the step of saving, by the customers, the video to their device for keeping.

29. The method of claim 1, further comprising the step of choosing an option, by the customer prior to death, from three types of videos, including the final farewell videos, the funeral videos, and the timeline videos so as to form chosen videos.

30. The method of claim 29, wherein said choosing step includes the step of mixing and matching the chosen videos as desired so long as there is an average of 12 mins, which is the total to be used in the initial package of 4K for the chosen videos, depending on the quality of the chosen videos, more or less time may be had.

31. The method of claim 29, wherein said choosing step includes the step of allowing customers to assign their videos into three options, namely, final farewell videos to be sent to an individual, a funeral farewell video to be played during their funeral ceremony, which can be a slide-show with pictures and songs of their choosing, or timeline videos that can be sent out in the future on a specified date.

32. The method of claim 29, wherein said choosing step includes relaying the types of videos that are personal or important home videos to a person/persons of their choosing.

33. The method of claim 1, further comprising the step of creating final farewell videos with home videos that one would want their children to have when they grow up or turn a certain age, with the videos being the most precious moments captured on a phone or other digital media that can be lost and/or never be seen by the people one would like most by holding those irreplaceable moments until a time of one's choosing at a future date or until verification of death, and then will be released to the recipients, with the included package allowing the customer to future date the release of the videos up to 10 years in advance with the option of adding additional 5 year increments up to a total of 20 years in the future, depending on the option the customer chooses.

34. The method of claim 33, said creating step includes the step of releasing the videos at the designated time/date the customer chooses or upon the verification of the customer's death.

35. The method of claim 1, further comprising the step of creating an e-mail address for the customer's children who do not have a cell phone or e-mail yet, even though they may not use it for some time so in the event that something does happen to the customer they will have the final farewell video.

36. The method of claim 35, wherein said creating step includes the step of designating a trusted friends or family member's cell phone and e-mail address for saving for receiving the final farewell video.

37. The method of claim 1, further comprising the step of purchasing, by the customer prior to death, additional videos for up to 5 mins of 4k video per video purchase.

38. The method of step 37, wherein said purchasing step includes the step of uploading an initial package and assigning the recipients of three videos, with the option to add/upload additional videos for additional costs.

39. The method of claim 1, further comprising the step of sending the chosen videos to a secured server site for storage where viewing of the chosen videos by no unauthorized person for maintaining confidentiality and security is not done.

40. The method of claim 1, further comprising the step of storing, by the customer prior to death, the most memorable video moments and ensuring they get to the recipients of the customer prior to death, when the time is right.

41. The method of claim 40, wherein said storing step includes storing on servers with an initial package for ten years with an option to increase in five year increments for an additional purchase.

42. The method of claim 1, further comprising the step of searching a database of the website to see if the searcher is a possible recipient of a final farewell video.

43. The method of claim 42, wherein said storing step includes the step of opting out, by the customer of the final farewell videos, of this search functionality when they create their FFV's from a main page of the website should they chose not to make themselves searchable for any reason.

44. The method of claim 42, wherein said searching step includes the step of showing the search option only if a person potentially made a final farewell video that is set to be released upon verification of death but does not show to whom it will be sent.

45. The method of claim 1, further comprising the step of updating the chosen videos and designated phone numeral/email addresses to be released and can be changed at any time from the website, with the chosen videos being deleted or changed at any time, or replaced any already made final farewell video at any time for no charge, and the customer prior to death can keep a previously made videos for a “time-line” effect and add a new final farewell video.

46. The method of claim 1, further comprising the step of adding, by the customer, after the initial twelve mins of video are used, additional video with five mins of video that can be purchased.

47. The method of claim 1, further comprising the step of after registering, a first tab of the website is the profile that includes filling out the customer's information including first/middle/last names, an address, an email, a phone number, an emergency contact's name and phone number, and an option to write a short bio message and user image.

48. The method of claim 47, wherein said after registering step includes uploading the videos from their device using the media gallery tab of the website.
